(19) United States
(12) Patent Application Publication
(10) Pub. No.: US 2003/0079055 A1
(43) Pub. Date: Apr. 24, 2003

(54) Shared input/output network management system

(75) Inventor: Ping-Chon Chen, Taipei (TW)

Correspondence Address: EDWARDS & ANGELL, LLP, 101 FEDERAL STREET, BOSTON, MA, 02110, US

(73) Assignee: Inventec Corporation, Taiwan, R.O.C.

(21) Appl. No.: 09/982,349

(22) Filed: Oct. 18, 2001

(51) Int. Cl. G06F 3/00

(52) U.S. Cl. 710/1

(57) ABSTRACT

A shared input/output network management system is proposed, which allows a group of I/O-unequipped computer units, such as a group of servers, to share one single set of I/O devices, including keyboard, monitor, and pointing device, for the purpose of allowing the user to perform management tasks, such as system updates, file maintenance, and hardware/software testing, on these servers through the single set of I/O devices. The proposed shared input/output network management system is characterized by the use of USB (Universal Serial Bus) communication interface, rather than a keyboard/video/mouse (KVM) switch, for connecting all the servers in the server group to a notebook computer running a server group management program, whereby management tasks can be carried out through the I/O devices of the notebook computer and the server group management program running on the notebook computer.

### BACKGROUND OF THE INVENTION

1. Field of the Invention

This invention relates to computer network technology, and more particularly, to a shared input/output network management system, which allows a group of I/O-unequipped computer units, such as a group of servers, to share one single set of I/O devices, including keyboard, monitor, and pointing device, so as to allow the user to perform management tasks, such as system updates, file maintenance, and hardware/software testing, on these servers through the single set of I/O devices.

2. Description of Related Art

A computer unit, such as a desktop personal computer (PC), is typically equipped with a set of I/O devices, including at least a keyboard, a monitor, and a pointing device (which can be either a mouse, a touchpad, or a trackball), for the purpose of allowing the user to operate the computer unit or perform certain management tasks on the computer's internal hardware/software configuration, such as system updates, file maintenance, and hardware/software testing.

In network applications, PCs are usually used as servers, such as database servers or an E-mail severs. In is case, since I/O devices are required only at the setup star and are unnecessary during server operation, they are typically removed to save equipment cost and room space. Therefore, servers are typically unequipped with I/O devices during operation.

However, there are circumstances when it is required to perform certain management tasks on the servers, such as when system crash occurs at one server, or when system updates and file maintenance are required. Since these management tasks require the use of I/O devices to perform, it would be a problem for the network manager.

One solution to the foregoing problem is to connect the server group to a network system and then connect an I/O-equipped computer unit via the network system to each of the servers in the server group. This allows the network manager to use the I/O-equipped computer unit to remotely perform management tasks on each server in the server group. One drawback to this solution, however, is that it is unsuited for use on servers that are installed at a place where no network facilities are provided

One solution to the foregoing problem is to use a keyboard/video/mouse (KVM) switch for selective connection of an I/O-equipped computer unit to the server group. This solution is illustratively depicted in the following with reference to FIG. 1.

FIG. 1 is a schematic diagram showing the system architecture of a conventional shared input/output network management system. As shown, this shared input/output network management system includes an I/O-equipped managing computer unit 100 (such as a desktop PC), a KVM switch 110,and a server group 120 (which includes a plurality of I/O-unequipped servers).

The managing computer unit 100 can be a desktop computer or a notebook computer, and which is provided with a set of I/O devices, including a keyboard 101, an LCD monitor 102, and a pointing device 103(which can be either a mouse, a touchpad, or a trackball).

The KVM switch 110 can be a mechanical type or an electronic type, which has one side connected via a KVM cable 111 to the managing computer unit 100 and the other side connected via a plurality of KVM cables 112 to each of the servers in the server group 120. The KVM switch 110 allows the user to selectively switch the connection of the KVM cable 111 to one of the KVM cables 112, thereby connecting the managing computer unit 100 to the selected one of the servers in the server group 120 to allow the user to use the managing computer unit 100 and its I/O devices 101, 102, 103 to perform management tasks via the KVM switch 110 on the selected one of the servers in the server group 120.

One drawback to the forgoing shared input/output network management system of FIG. 1, however, is that the KVM switch and the dedicated KVM cables are costly to purchase, which would undesirably increase the cost of implementation.

### SUMMARY OF THE INVENTION

It is therefore an objective of this invention to provide a shared input/output network management system, which allows a group of computer units that are unequipped with I/O devices to share one single set of I/O devices so as to allow the user to perform management tasks on each of these computer units through the single set of I/O devices.

It is another objective of this invention to provide a shared input/output network management system, which can be implemented without using KVM switch, so as to be more cost effectively to implement than the prior art.

It is still another objective of this invention to provide a shared input/output network management system, which can help increase the efficiency of server group management.

In accordance with the foregoing and other objectives, the invention proposes a novel shared input/output network management system.

Broadly recited, the shared input/output network management system according to the invention comprises: (a) a computer group including a plurality of computer units, which are each equipped with a communication interface, and which are interconnected via the communication interface; and (b) a managing computer unit, which includes: (b1) a communication interface, which is compliant with and connected to -the communication interface of the computer group; (b2) a set of I/O devices, which can be coupled via the communication interface of the managing computer unit to a user-selected one of the computer units in the computer group; and (b3) a computer group management program, which allows user to select one of the computer units in the computer group and perform management tasks on the selected computer unit in the computer group via the I/O devices.

The foregoing shared input/output network management system allows a group of I/O-unequipped computer units, such as servers, to share one single set of I/O devices, including keyboard, monitor, and pointing device, for the purpose of allowing the user to perform management tasks, such as system updates, file maintenance, and hardware/software testing, on these servers through the single set of I/O devices. Compared to the prior art, since the shared input/output network management system of the invention requires only the use of USB cables, and no KVM switches, the invention is apparently more convenient and cost-effective to implement than the prior art.

### BRIEF DESCRIPTION OF DRAWINGS

The invention can be more fully understood by reading the following detailed description of the preferred embodiments, with reference made to the accompanying drawings, wherein:

FIG. 1 (PRIOR ART) is a schematic diagram showing the configuration of a conventional shared input/output network management system;

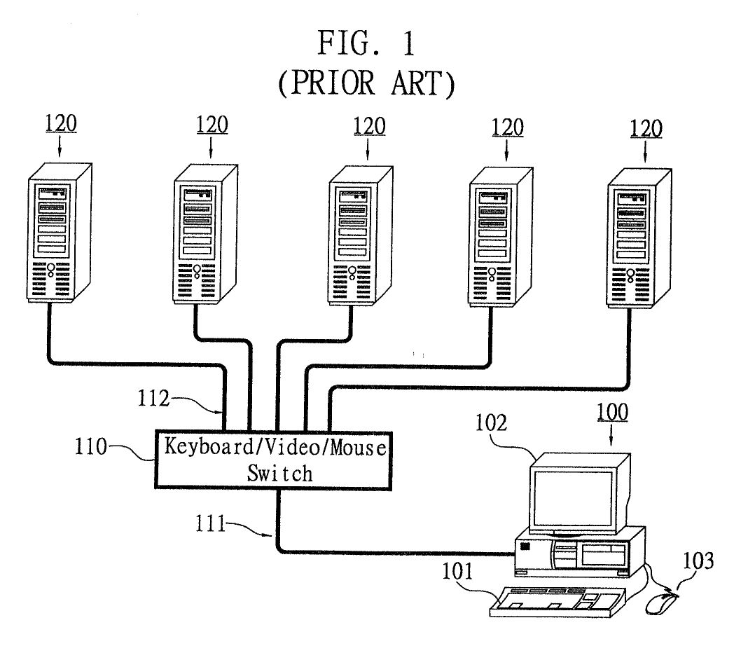

FIG. 2 is a schematic diagram showing the configuration of the shared input/output network management system according to the invention; and

FIG. 3 is a schematic diagram showing the internal architecture of the shared input/output network management system according to the invention.

### DETAILED DESCRIPTION OF PREFERRED EMBODIMENTS

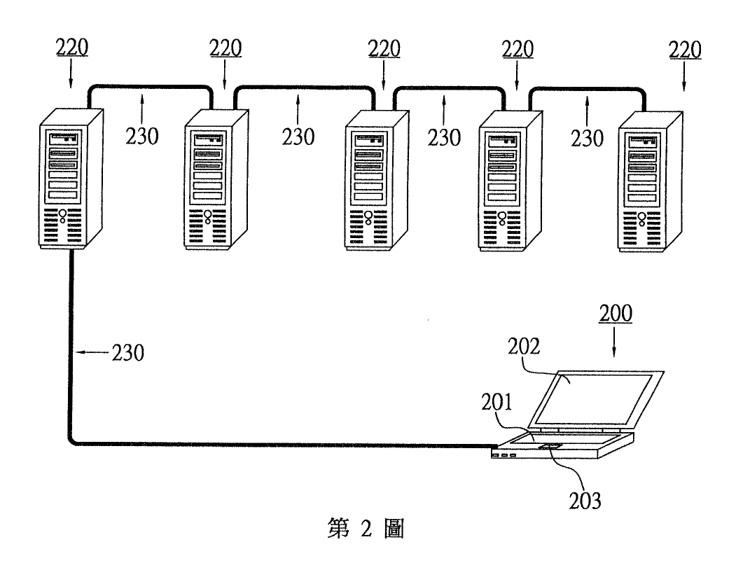

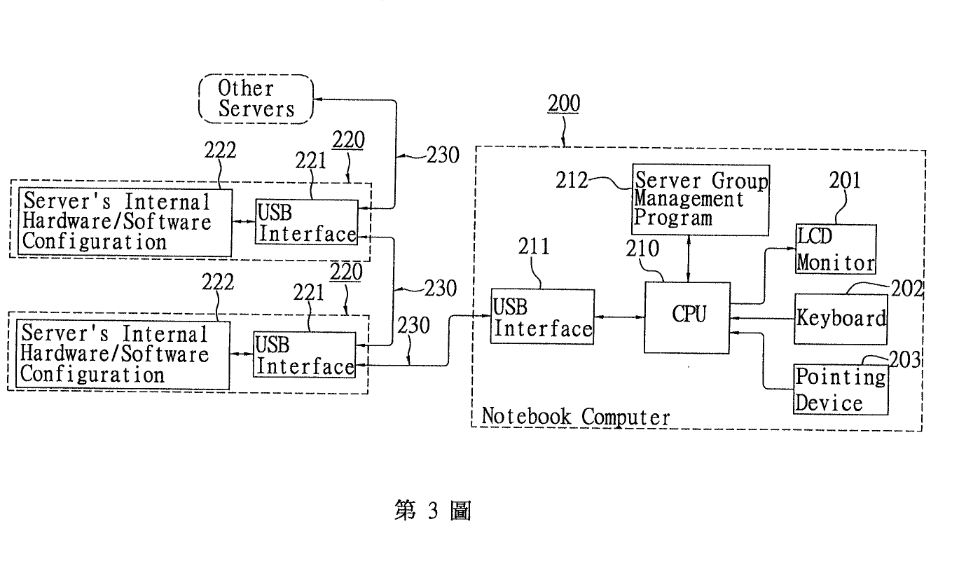

The shared input/output network management system according to the invention is disclosed in full details by way of a preferred embodiment in the following with reference to FIG. 2 and FIG. 3.

Referring first to FIG. 2, the shared input/output network management system according to the invention comprises an I/O-equipped managing computer unit 200 and a group of I/O-unequipped computer units, such as a group of servers 220. It is an important aspect of the invention that these servers 220 are serially connected in chain and to the managing computer unit 200 by means of USB cables 230.

Referring to FIG. 3 together with FIG. 2, the managing computer unit 200 is preferably a portable computer, such as a notebook computer; but any type of I/O-equipped computer unit is applicable. The managing computer unit 200 includes a CPU 210 and a USB interface 211 and is equipped with a set of I/O devices, including a keyboard 201, an LCD monitor 202, and a pointing device 203 (which can be either a touchpad or a mouse). It is to be noted that FIG. 3 is a simplified diagram which shows only those system components that are related to the invention; other system components are eliminated for simplification of the drawing.

The CPU 210 is used to control the data communication between the USB interface 211 and the I/O devices 201, 202, 203 and is further capable of executing a server group management program 212. This server group management program 212 allows the user to perform certain management tasks on the servers 220, such as system updates, file maintenance, hardware/software testing, and so on.

The servers 220 should be each equipped with a USB interface 221 so as to allow the internal hardware/software configuration 222 to be serially connected in chain and to the USB interface 211 of the managing computer unit 200 via USB cables 230.

In actual use, the user (i.e., the network manager or maintenance engineer) should first run the server group management program 212 through the use of the keyboard 201, the LCD monitor 202, and the pointing device 203, which allows the user to link the managing computer unit 200 to the servers 220 via the USB cables 230 and select one of the servers 220 to be managed. When selection is made, the user then can operate the server group management program 212 to perform certain management tasks on the selected one of the servers 220, such as system updates, file maintenance, and hardware/software testing. All of these management tasks are operated via the keyboard 201, the LCD monitor 202, and the pointing device 203 on the managing computer unit 200. Since these management tasks are well-known tasks, description thereof will not be further detailed.

In application, the invention can be utilized in various ways. For example, it can be installed permanently on a group of servers so as to allow the user to monitor the operations of these servers and perform required management tasks when necessary. Alternatively, it can be pre-built in a USB-equipped notebook computer for a maintenance engineer to perform management tasks on a group of standalone servers by connecting these servers to the notebook computer with USB cables when maintenance on the servers is required. This allows the maintenance engineer to use notebook computer to perform management tasks on any types of server groups.

In conclusion, the invention provides a shared input/output network management system which allows a group of I/O-unequipped computer units, such as a group of servers, to share one single set of I/O devices via USB connections, so as to allow the user to perform management tasks, such as system updates, file maintenance, and hardware/software testing, on these servers through the single set of I/O devices.

Compared to the prior art, since the shared input/output network management system of the invention requires only the use of USB cables, and no KVM switches, the invention is apparently more convenient and cost-effective to implement than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A shared input/output network management system, which comprises;
(a) a computer group including a plurality of computer units, which are each equipped with a communication interface, and which are interconnected via the communication interface; and
(b) a managing computer unit, which includes:
(b1) a communication interface, which is compliant with and connected to the communication interface of the computer group;
(b2) a set of I/O devices, which can be coupled via the communication interface of the managing computer unit to a user-selected one of the computer units in the computer group; and
(b3) a computer group management program, which allows user to select one of the computer units in the computer group and perform management tasks on the selected computer unit in the computer group via the I/O devices.

2. The shared input/output network management system of claim 1, wherein the computer units in the computer group are each a server.

3. The shared input/output network management system of claim 1, wherein the managing computer unit is a notebook computer.

4. The shared input/output network management system of claim 1, wherein the communication interface of the computer group and the communication interface of the managing computer unit are compliant with USB 2.0 standard.

5. The shared input/output network management system of claim 1, wherein the I/O devices include a keyboard, an LCD monitor, and a pointing device.

6. A shared input/output network management system, which comprises:
(a) a server group including a plurality of servers, which are each equipped with a USB interface, and which are interconnected via the USB interface; and
(b) a managing computer unit, which includes:
(b1) a USB interface which is compliant with and connected to the USB interface of the server group;
(b2) a set of I/O devices, which can be coupled via the USB interface of the managing computer unit to a user-selected one of the servers in the server group; and
(b3) a server group management program, which allows user to select one of the servers in the server group and perform management tasks on the selected server in the server group via the I/O devices.

7. The shared input/output network management system of claim 6, wherein the managing computer unit is a notebook computer.

8. The shared input/output network management system of claim 6, wherein the I/O devices include a keyboard, an LCD monitor, and a pointing device.

9. A shared input/output network management system, which comprises:
(a) a server group including a plurality of servers, which are each equipped with a USB interface, and which are interconnected via the USB interface; and
(b) a notebook computer, which includes:
(b1) a USB interface which is compliant with and connected to the USB interface of the server group;
(b2) a set of I/O devices, which can be coupled via the USB interface of the notebook computer to a user-selected one of the servers in the server group; and
(b3) a server group management program, which allows user to select one of the servers in the server group and perform management tasks on the selected server in the server group via the I/O devices.
